(19) United States
(12) Patent Application Publication
(10) Pub. No.: US 2011/0051581 A1
(43) Pub. Date: Mar. 3, 2011

(54) VIBRATION ANALYSIS METHODOLOGY USING DATA STORAGE DEVICES

(75) Inventors: Peter R. Janik, Shakopee, MN (US); Scott Douglas Ulrich, Apple Valley, MN (US); Paul William Burnett, Savage, MN (US); Brian Pollock, Eden Prairie, MN (US)

(73) Assignee: Seagate Technology LLC, Scotts Valley, MN (US)

(21) Appl. No.: 12/547,380

(22) Filed: Aug. 25, 2009

(51) Int. Cl. G11B 27/36; G01H 17/00; G06F 19/00; G08B 21/00

(52) U.S. Cl. 369/53.42; 702/56; 340/540; G9B/27.052

(57) ABSTRACT

A method includes acquiring, by a data storage device, signals generated by one or more sensors that relate to a mechanical vibration of the data storage device. The one or more sensors are in electrical communication with the data storage device. The method includes storing a representation of the signals as data in the data storage device.

### BACKGROUND

Disc drives are digital data storage devices that enable users of computer systems to store and retrieve large amounts of data in a fast and efficient manner. Disc drives of the present generation have data storage capacities in excess of hundreds of gigabytes (GB) and can transfer data at sustained rates of one hundred megabytes (MB) per second or greater.

A typical disc drive includes a plurality of magnetic recording discs, which are mounted to a rotating hub of a spindle motor for rotation at a constant, high speed. An array of read/write heads is disposed on adjacent surfaces of the discs to transfer data between the discs and a host computer. The heads are radially positioned over the discs by a rotary actuator and a closed loop, digital servo system, and are caused to fly proximate the surfaces of the discs upon air bearings established by air currents set up by the high speed rotation of the discs.

A plurality of nominally concentric tracks are defined on each disc surface. A preamplifier and driver circuit generates write currents that are used by the head to selectively magnetize the tracks during a data write operation and amplifies read signals detected by the head during a data read operation. A read/write channel and interface circuit are operably connected to the preamplifier and driver circuit to transfer the data between the discs and the host computer.

Disc drives may be used in a stand-alone fashion, such as in a typical personal computer (PC) configuration, where a single disc drive is utilized as the primary data storage peripheral. Alternatively, in applications requiring great amounts of data storage capacity or high input/output (I/O) bandwidth, a plurality of drives can be arranged into a multi-drive array, such as a RAID (“Redundant Array of Inexpensive Discs”; also “Redundant Array of Independent Discs”).

### SUMMARY

In one example, the disclosure is directed to a method comprising acquiring, by a data storage device, signals generated by at least one sensor that relate to a mechanical vibration of the data storage device, wherein the at least one sensor is in electrical communication with the data storage device, and storing a representation of the signals as data in the data storage device.

In another example, the disclosure is directed to a system comprising a data storage device, and at least one sensor that generates signals related to a mechanical vibration of the data storage device, wherein the at least one sensor is in electrical communication with the data storage device, and wherein the data storage device acquires the signals and stores a representation of the signals in the data storage device.

In another example, the disclosure is directed to a computer-readable medium comprising instructions that cause a processor in electrical communication with a data storage device to acquire signals generated by at least one sensor that relate to a mechanical vibration of the data storage device, wherein the at least one sensor is in electrical communication with the data storage device, and to store a representation of the signals as data in the data storage device.

In another example, the disclosure is direct to a system comprising a data storage device, at least one sensor that generates signals related to a mechanical vibration of the data storage device, wherein the at least one sensor is in electrical communication with the data storage device, and wherein the data storage device acquires the signals and stores a representation of the signals in the data storage device, and a chassis configured to support a plurality of data storage devices.

These and various other features and advantages will be apparent from a reading of the following detailed description.

### BRIEF DESCRIPTION OF THE DRAWINGS

FIG. 1 is a top plan view of an example data storage device that may be used for evaluation of cabinet rotational vibration (RV) and linear vibration (LV) characterization and adverse resonance identification in accordance with this disclosure.

FIG. 2 is an outline plan view of a printed circuit board assembly of the data storage device of FIG. 1 having a sensor attached thereto in accordance with this disclosure.

FIG. 3 is a front view of an example cabinet configured to support a plurality of data storage devices.

FIG. 4 is a conceptual block diagram illustrating one example data storage device configured to act as a data acquisition system, in addition to being a data storage device.

FIG. 5 depicts a graph illustrating one example of a position error signal that may be captured and recorded using the techniques of this disclosure.

FIG. 6 depicts a graph illustrating a position error signal after a transform has been performed on the signal.

FIG. 7 depicts a graph illustrating rotational vibration data measured with accelerometers mounted external to a data storage device.

FIG. 8 is a flow chart illustrating an example method for using a data storage device as a data acquisition system for linear vibration data and rotation vibration data, in addition to being a storage device.

### DETAILED DESCRIPTION

In general, this disclosure describes techniques for using the data storage device under evaluation for cabinet rotational vibration (RV) and linear vibration (LV) characterization and adverse resonance identification. By using the data storage device itself as an instrument for detecting resonant frequencies, a customer's data storage device acceptance qualification time may be improved. By improving a customer's drive acceptance qualification time, time-to-market may be decreased for both the data storage device supplier and the customer. In addition, using the data storage device itself as an instrument for detecting resonant frequencies may increase the amount of information available to design teams and engineers, e.g., the cabinet design team and servo engineers. Further, using the data storage device itself as an instrument for detecting resonant frequencies simplifies and reduces the time required to perform the traditional method of measuring vibration using accelerometers attached to the outer casing of the data storage device, e.g., a disc drive. Further still, using the data storage device itself to detect resonant frequencies automates a data collection process that was previously labor intensive and time consuming.

As mentioned above, disc drives may be used in a stand-alone fashion, such as in a typical personal computer (PC) configuration where a single disc drive is utilized as the primary data storage peripheral. Alternatively, in applications requiring great amounts of data storage capacity or high input/output (I/O) bandwidth, a plurality of drives can be arranged into a multi-drive array, such as a RAID (“Redundant Array of Inexpensive Discs”; also “Redundant Array of Independent Discs”). When one or more drives are used in a multi-drive array, fans and other devices mounted within the chassis in which the drive(s) are mounted may cause resonances that stimulate the chassis, thereby causing the chassis and the drive(s) to vibrate. High vibration levels adversely affect disc drive operation.

The traditional method of using accelerometers to measure the vibration is often not practical, and sometimes not possible, because the space allowed between multiple drives or other hardware in a cabinet, for example, may be too small to allow accelerometers to be placed on the outer casing of the data storage device without modifying the conditions of the cabinet itself. Of course, modifying the cabinet to allow for accelerometers and other test equipment changes the test conditions and, as such, is not an accurate representation of the system. Further still, the traditional method of using accelerometers is often limited to measuring vibrations on a small number of drives due to channel limitations of the test equipment.

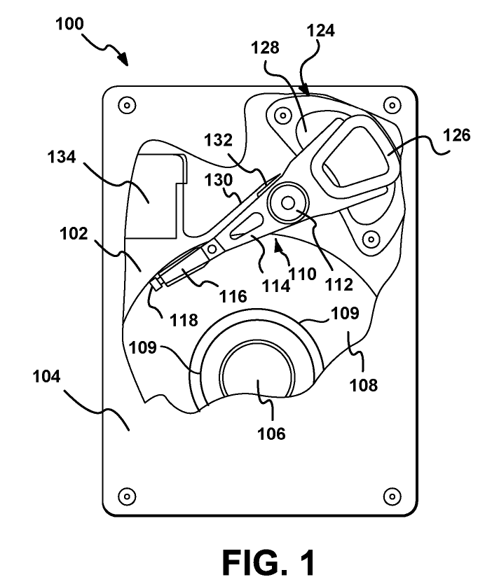

FIG. 1 shows an illustration of one example of data storage device 100 that may be used as an instrument for cabinet rotational vibration (RV) and linear vibration (LV) characterization and adverse resonance identification. In the example shown in FIG. 1, data storage device 100 is illustrated as a hard disc drive. However, it shall be understood that other types of data storage devices may also be used, and that the specific embodiment shown and described herein is for illustrative purposes only and is not a limitation of the present invention. For example, data storage device 100 may be a magnetic disc drive, optical disc drive, solid-state drive, or another device.

Disc drive 100 includes base 102 to which various components of disc drive 100 are mounted. Top cover 104, shown partially cut away, cooperates with base 102 to form an internal, sealed environment for the disc drive in a conventional manner. The components include spindle motor 106 that rotates one or more discs 108 at a constant high speed. Information is written to and read from tracks on discs 108 through the use of an actuator assembly 110, which rotates during a seek operation about bearing shaft assembly 112 positioned adjacent discs 108. Actuator assembly 110 includes a plurality of actuator arms 114 that extend towards discs 108, with one or more flexures 116 extending from each of actuator arms 114. Mounted at the distal end of each of flexures 116 is read/write head 118 which includes an air bearing slider (not shown) enabling head 118 to fly in close proximity above the corresponding surface of the associated disc 108.

During a seek operation, the position of read/write heads 118 over discs 108 is controlled through the use of voice coil motor (VCM) 124, which typically includes coil 126 attached to actuator assembly 110, as well as one or more permanent magnets 128 which establish a magnetic field in which the coil 126 is immersed. The controlled application of current to coil 126 causes magnetic interaction between permanent magnets 128 and coil 126 so that coil 126 moves in accordance with the well known Lorentz relationship. As coil 126 moves, actuator assembly 110 pivots about bearing shaft assembly 112, and heads 118 are caused to move across the surfaces of discs 108.

Flex assembly 130 provides the requisite electrical connection paths for actuator assembly 110 while allowing pivotal movement of actuator assembly 110 during operation. The flex assembly includes printed circuit board 132 to which head wires (not shown) are connected. The head wires are routed along actuator arms 114 and flexures 116 to heads 118. Printed circuit board 132 typically includes circuitry for controlling the write currents applied to heads 118 during a write operation and a preamplifier for amplifying read signals generated by the heads 118 during a read operation. The flex assembly terminates at flex bracket 134 for communication through base deck 102 to a disc drive printed circuit board (not shown) mounted to the bottom side of disc drive 100.

As shown in FIG. 1, located on the surface of discs 108 are a plurality of nominally circular, concentric tracks 109 (only one of which is shown). Each track 109 preferably includes a number of servo fields that are periodically interspersed with user data fields along the track 109. The user data fields are used to store user data and the servo fields used to store servo information used by a disc drive servo system to control the position of the read/write heads.

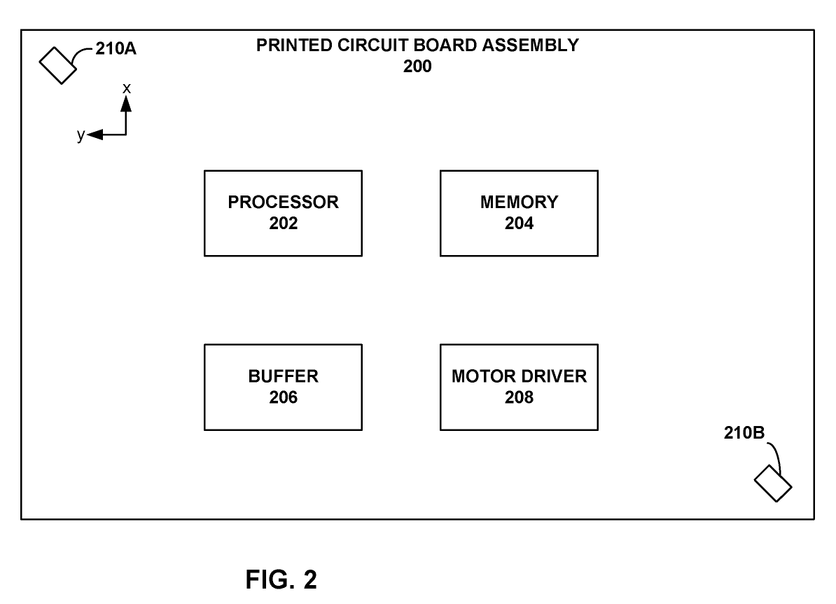

FIG. 2 is an outline plan view of an example printed circuit board assembly (PCBA) of the data storage device of FIG. 1. In one example, PCBA 200 or 132 may include a processor 202, memory device 204, buffer 206, motor driver 208, and at least one sensor 210A and/or 210B. Sensors 210A and 210B need not be the same type of sensor. It should be noted that the positioning and x-y orientation of processor 202, memory device 204, buffer 206, and motor driver 208 depicted in FIG. 2 is for ease of illustration purposes only and is in no manner meant to suggest a particular layout of the devices.

Processor 202 may be configured to perform a number of tasks, including controlling VCM 124 in order to move head 118 across the surface of discs 108, directing head 118 to read data from or write data to disc 108, and transmitting the data between data storage device 100 and the central processing unit (CPU) of a computer (not shown) in communication with data storage device 100.

Memory device 204 may be configured to store instructions executable by processor 202. While memory device 204 is shown as a separate device in FIG. 2, in some examples, memory device 204 is integral with processor 202. Memory device 204 may include read only memory (ROM), programmable read only memory (PROM), erasable programmable read only memory (EPROM), electronically erasable programmable read only memory (EEPROM), and flash memory, for example.

Buffer 206 may be a random access memory (RAM) device configured to temporarily store data that is frequently accessed by the drive, thereby potentially increasing the data transfer rate between data storage device 100 and the computer, and reducing the wear on the discs 108.

Motor driver 208 is an integrated circuit device that amplifies the current from processor 202. By itself, processor 202 may not source enough current to drive VCM 124. As such, PCBA 200 may include motor driver 208 which amplifies signals received from processor 202 in order to drive VCM 124.

Exposure to shock and vibration may adversely affect the integrity of data storage device 100. Disc drives are particularly susceptible to high vibration levels. For example, elevated rotational vibration levels may decrease data transfer rates, comprise data integrity, or result in permanent damage to the storage medium. In order to detect rotational vibration, linear vibration, and/or shock to data storage device 100, PCBA 200 further includes one or more sensors 210A and/or 210B.

Sensors 210A and/or 210B may be rotational vibration (RV), linear vibration (LV), and/or shock sensors mounted on PCBA 200 and in electrical communication with processor 202. In some examples, sensors 210A and/or 210B may be a micro-electromechanical system, or MEMS, based device. In one specific example, sensors 210A and/or 210B may be MEMS-based linear vibration sensors such as the LIS3LV02DL three-axis linear accelerometer available from ST Microelectronics. In one example, the vibration sensor may be an accelerometer.

In some examples, linear vibration sensors may be used to calculate the rotational vibration of data storage device 100. For example, as seen in FIG. 2, sensors 210A and 210B are oriented with respect to an x-y axis such that any motion of PCBA 200, and thus data storage device 100, will include both an x-component and a y-component. Processor 202 may then execute an algorithm stored in memory 204, for example, that determines the rotational vibration of data storage device 100 based on the x and y components of motion measured by sensors 210A and/or 210B. It should be noted that two or more sensors may be needed in order to calculate the rotational vibration of data storage device 100.

In addition, PCBA 200 may include other sensors that are in place of or in addition to the LV, RV, and/or shock sensors 210A and/or 210B. In one example, PCBA 200 may include temperatures sensors for measuring the temperature of data storage device 100. In another example, PCBA 200 may include a humidity sensor for measuring the humidity within data storage device 100. Processor 202 may periodically record to data storage device 100 the temperature and humidity conditions present within data storage device 100, thus providing additional information that may be useful in resolving any fault conditions that may occur.

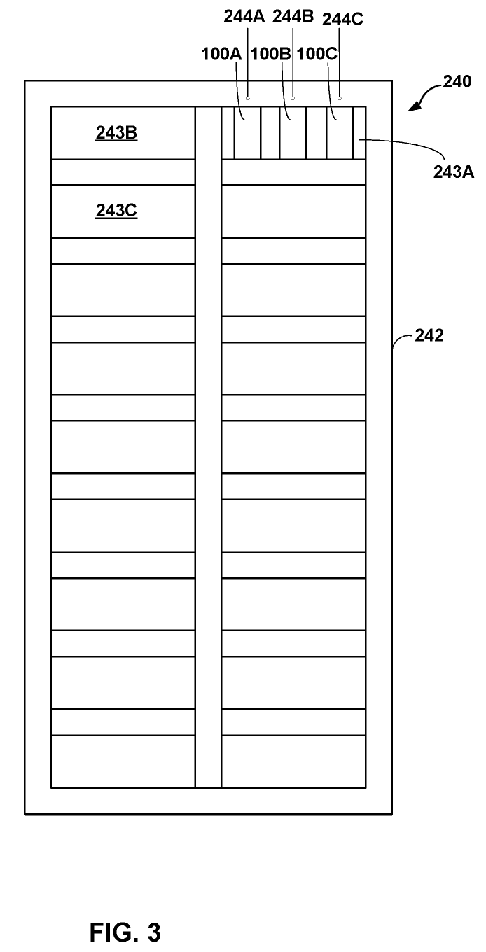

FIG. 3 is a front view of cabinet 240 configured to support a plurality of data storage devices 100. Cabinet 240 includes a frame system 242 that may divide the cabinet into a plurality of quadrants 243A-C, with each quadrant configured to support a plurality of data storage devices 100. For ease of illustration, cabinet 240 in FIG. 3 is depicted with only a single quadrant 243A supporting three data storage devices, namely data storage devices 100A, 100B, and 100C. As will be discussed in more detail below, cabinet 240 may further include light-emitting diodes (LEDs) to provide a visual indication of an error condition, for example, to an operator monitoring operation or testing of the data storage devices 100. FIG. 3 depicts three LEDs, 244A, 244B, and 244C (collectively, “LEDs 244”) to provide visual indication of an error condition for corresponding storage devices 100A, 100B, 100C, for example. In some examples, a quadrant, e.g., quadrant 243A, may include only a single LED 244 to provide visual indication of an error in any of data storage devices 100A, 100B, and 100C.

Although not depicted in FIG. 3, cabinet 240 may further include fans and other devices that act as vibration driving forces. The frequency of these driving forces may stimulate cabinet 240, and thus any data storage devices 100 attached to cabinet 240, to vibrate. If the frequency of these driving forces corresponds with any resonant frequency of data storage device 100, the resulting resonance in the data storage device may compromise the read/write integrity of the data storage device, the servo system of the drive, or the like. As such, it is desirable to identify and quantify adverse resonances and frequencies that are associated with degraded storage device performance or other storage device issues.

In accordance with this disclosure, RV, LV, and/or shock sensors 210A and/or 210B mounted on PCBA 200 of data storage device 100 may be used in conjunction with logging technologies, e.g., logging software, to allow data storage device 100 to monitor and capture data representative of the adverse resonances and frequencies that are associated with degraded storage device performance or other device issues. By using sensors 210A and/or 210B in conjunction with logging technologies, data storage device 100 may be used as a tool to log any resonance present in the cabinet. Thus, data storage device 100 is transformed from simply a storage medium to a sensing mechanism to aid in qualifying and modifying the design of a cabinet.

Logging software capable of capturing data representing frequency signals present in cabinet 240 may be stored on data storage device 100. For example, in one example, the logging software may include two complimentary modules of monitoring technologies. A first module of monitoring technology may provide for a low sample, periodic accumulation of data for as long a period as desired, including for the life of data storage device 100. In one example, the data may be, for example, linear vibration (LV) data generated by sensors 210A and/or 210B that is converted by processor 202 via an algorithm stored in memory 204 to rotational vibration (RV) data. In other examples, the data may be RV data that is generated directly by sensors 210A and/or 210B. In either case, the first module of monitoring technology may record the RV data to disc 108. For example, the magnitude of RV encountered by data storage device 100 during its operation may be recorded to disc 108. The magnitude of RV encountered may then be compared with an RV profile of data storage device 100, thereby allowing processor 202 to determine whether data storage device 100 conforms with the product specification.

In some cases it may be desirable for the first module to include instructions that cause processor 202 to record the absolute mean of the RV data over specific periods of time, e.g., an average of RV data over a fixed or predetermined amount of time, to disc 108. Instead of or in addition to recording the absolute mean of the RV data, it may be desirable for the first module to be include instructions that, when executed, cause processor 202 to record the maximum absolute mean of the RV data, e.g., the highest value of RV sensed in the last sample, to disc 108.

In some examples, this first module of monitoring technology may allow a user to change the sampling rate, either manually or automatically. For instance, the sampling rate may be set at one hour, but be configurable to sample at four minutes or lower. Of course, increasing the sampling rate in this manner results in a large amount of information in a short period of time, thereby reducing the time needed to gather the frequency information necessary to resolve any potential design issues. One specific example of monitoring technology that may be used is Self-Monitoring, Analysis, and Reporting Technology (“SMART”).

SMART logging technology may allow a “threshold” to be set in order to determine design margins and boundary conditions associated with the cabinet design. For example, using SMART, a threshold may be set for either or both an RV and LV condition. When either the RV or LV condition is violated, e.g., the recorded data exceeds the threshold, the SMART technology may produce a warning that informs the host of the violation.

A second module of monitoring technology may also be used for logging purposes. Unlike the first module, e.g., SMART technology, the second module of monitoring technology may be used for an event-driven capture of information. If an error condition occurs, the second module of monitoring technology may capture more details of events than the first module. One specific example of monitoring technology that may be used is the Unified Debug System (“UDS”) logging technology. For example, during an error condition, the UDS logging may automatically record the frequency content, the LV and x-y coordinates from sensors 210A and/or 210B, the RV (after the RV has been calculated from the LV and x-y coordinates, or measured by RV sensors), and a time-stamp (day and time) indicating when the error condition occurred.

Each data storage device 100 present within cabinet 240 may record the time-stamp, thus allowing any data recorded on data storage devices 100 to be time-aligned. Time-alignment may be useful in determining that a particular condition present within cabinet 100 at a given time affected only a particular set of data storage devices 100, or all data storage devices 100. For example, during an error condition, the second module of monitoring technology may cause processor 202 to record a time stamp for all drives present within cabinet 240 of FIG. 3, thereby indicating that an error condition occurred. The second module may then cause processor 202 to record the error data to the particular drives in which the error condition occurred. At a later time when the error data is retrieved and time-aligned, it may be determined, for example, that only the data storage devices located in quadrant 243A, for example, of cabinet 240 recorded an error condition at the time indicated by the time stamp. Using this information, combined with the frequency information recorded, it may determined that a cooling fan, for example, located in quadrant 243A of cabinet 240 turned on at that time, and as such, may be the cause of the adverse resonance condition that produced the recorded error.

In some examples, the first module of logging technology may issue a command to the second module of logging technology in order to begin logging data. In other examples, a command to the second module of logging technology to begin logging may be an instruction issued by processor 202 as part of the general error recovery procedures used by data storage device 100.

In one example, the second module of logging technology may include position error signal (PES) sampling. PES sampling may allow data storage device 100 to capture the frequency components introduced by cabinet 240. That is, PES sampling provides a tool that enables data storage device 100 to record frequencies present within the bandwidth of the servo system of data storage device 100. PES sampling may allow, for example, processor 202 to determine whether data storage device 100 is beyond the data storage device's on-cylinder limit, i.e., beyond the limit at which data storage device 100 can stay on a track. The on-cylinder limit, in some examples, may be an upper and lower limit, each represented by a percentage, e.g., an upper limit of +16% and a lower limit of −16%. In one example, the second module may capture and store a number of position error signal sample points. In some examples, the position error signal is recorded along with the segment and position information, e.g., the wedge number of the data storage unit. Once these sample points are recorded, a transform, e.g., fast Fourier transform (FFT), discrete Fourier transform (DFT), or other similar transform that converts data representing a signal to the frequency domain, may be performed on the recorded data in order to determine the frequency content of the vibrations present within the system. Once the frequency content of the vibrations is determined, a design engineer may use this frequency information to aid in investigating the source of the resonance present within cabinet 240. For example, the frequency information may lead an engineer to determine that the source of the resonance was a cooling fan or some other hardware present within cabinet 240.

In some examples, the second module may record additional information related to the error, e.g., the error generated by excessive vibration. The second module may record an error code that indicates the error type, e.g., hardware error. The second module may also record the trigger capture mechanism by which the error was captured, e.g., read-recovery operation, write-recovery, and UDS logging. The second module may also record the servo firmware version and/or the interface firmware version. As mentioned above, the time at which the error occurred may be recorded via a time stamp. In addition, the second module may also record the power cycle count. The second module may also record the number of captures within a data set in an index, for example. The second module may also record the location of the data storage device where the error occurred, e.g., a logical block address. Of course, these are just some non-limiting examples of the information that may be recorded. Other examples not specifically mentioned are nevertheless considered to form part of this disclosure.

The logging features of the first module and the second module may be turned on and turned off, or invoked, via a switch, for example. In some examples, the switch may be turned on or off via mode pages, e.g., using Serial Attached SCSI (“SAS”)/Fiber Channel and SCSI. That is, a customer, for example, may modify the mode page settings of the data storage device such that the data storage device will operate as a standard drive, or in accordance with the techniques of this disclosure, as a data acquisition system for LV, RV, shock, temperature, humidity, or the like. Mode page is a method that reports and modifies configurational changes within a data storage device. In one example, setting the mode page may include setting a bit. The bit may be set via hardware or software.

In other examples, e.g., AT Attachment (ATA), the logging may be turned on by using SMART command transport (SCT) protocol with a unique action code and function code value that allows similar functional behavior. That is, an SCT command may be sent to a data storage device having an ATA interface using a specific action code. SCT action codes are analogous to mode page settings and allow reporting of and modification to the configuration of the data storage device.

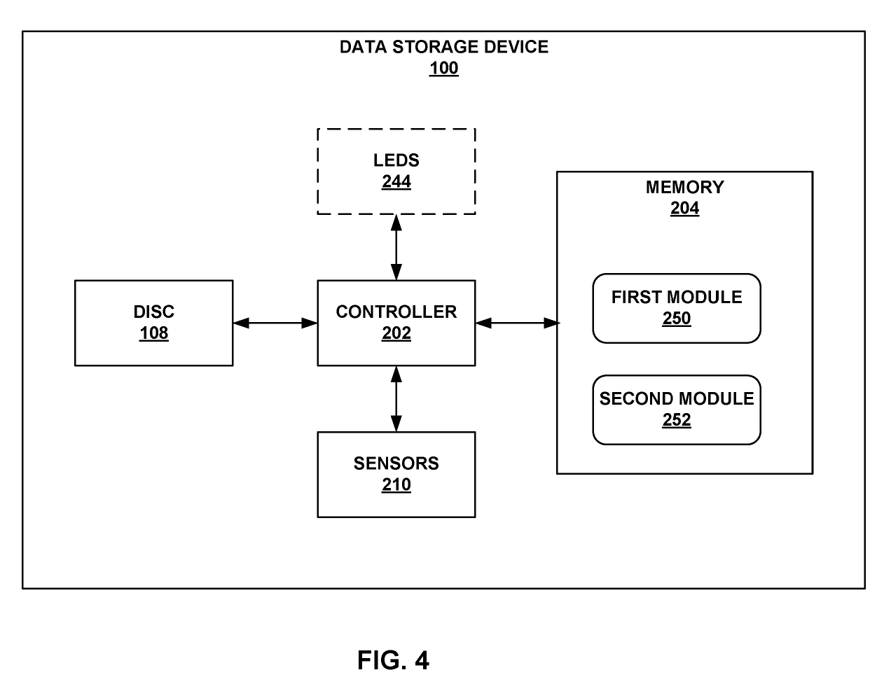

FIG. 4 is a conceptual block diagram illustrating one example data storage device 100 configured to act as a data acquisition system, in addition to being a data storage device. In FIG. 4, processor 202 is depicted as being in electrical communication with disc 108, sensors 210A and/or 210B (shown as “sensors 210” for simplicity), memory 204, and LEDs 244. Stored within memory 204 are the first module 250, or low sample rate module, of monitoring technology, and the second module 252, or event driven module, of monitoring technology. In one specific example, first module 250 may comprise SMART technology and second module 252 may comprise UDS logging technology. First module 250 and second module 252 are depicted as separate modules. However, it should be noted that in some examples, the two modules may be combined into a single module that includes the features of both the first module and the second module.

Processor 202 is also in electrical communication with sensors 210A and/or 210B. Sensors 210A and/or 210B may include rotational vibration (RV), linear vibration (LV), and/or shock sensors. Sensors 210A and/or 210B may also include numerous other types of sensors that may be used to collect information relevant to error conditions. For example, sensors 210A and/or 210B may be temperature sensors, humidity sensors, or the like.

Processor 202 is also in electrical communication with LEDs 244. The dotted line around LEDs 244 in FIG. 4 indicates that the LEDs may be located on data storage device 100, on cabinet 240, or both. LEDs 244 may provide a visual indication as a warning to an operator, technician, engineer, or other personnel monitoring the data storage devices stored within cabinet 240 that an error condition has occurred. For example, LEDs 244A-C may provide a visual indication to the person monitoring the testing of data storage devices 100A-C if an RV threshold is exceeded in the corresponding data storage devices 100A-C. For ease of illustration purposes, LED driver circuitry that may be required to pulse LEDs 244 has not been depicted. In some examples, in addition to or instead of a visual indication, an aural indication, e.g., via a speaker, may be provided in order to warn of an error condition, e.g., exceeding a threshold.

Processor 202 is also in electrical communication with disc 108 of data storage device 100. Information received by processor 202 via sensors 210A and/or 210B is written to a portion of disc 108. As non-limiting examples, vibration and shock data, as well as temperature and humidity data may be written to disc 108. In some examples, the portion of disc 108 in which the information is written may be a predefined area, e.g., a specific sector. In other examples, the portion of disc 108 may be the first sector of the disc or the last sector of the disc. In examples in which data storage device 100 is a solid-state drive, the portion in which information from sensors 210A and/or 210B is written may be predefined page or erasure block.

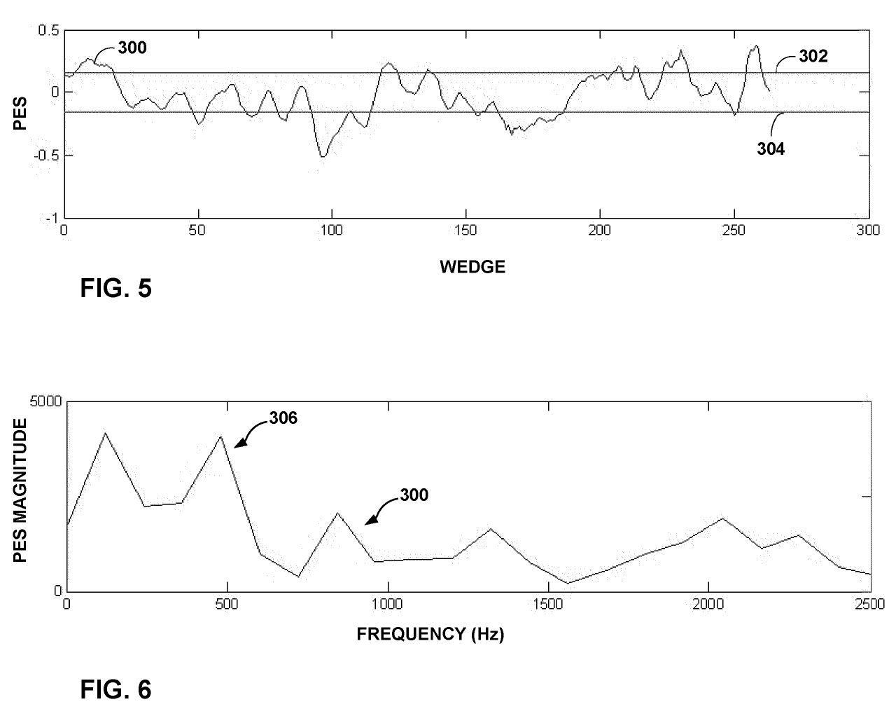

FIG. 5 depicts a graph illustrating one example of a position error signal (PES) that may be captured and recorded using the techniques of this disclosure. FIG. 5 plots the data samples representing position error signal 300 captured and recorded to data storage device 100 and, in particular, second module 252. The x-axis is the wedge number of data storage device 100 and the y-axis is a percentage of head 118 being off track, e.g., 0.1 is 10% off track, where 302 and 304 represent the boundaries for the head to be considered on track, i.e., the on-cylinder limit. In particular, FIG. 5 illustrates how position error signal 300 varies across the wedges of data storage device 100.

FIG. 6 depicts a graph illustrating position error signal (PES) 300 of FIG. 5 after a transform, e.g., a fast Fourier transform, has been performed on the signal. In other words, FIG. 6 is graph illustrating position error signal 300 of FIG. 5 represented in the frequency domain. The y-axis represents the magnitude, or energy, of position error signal 300 (“PES magnitude”) and the x-axis represents frequency in Hertz (Hz). As seen in FIG. 6, most of the energy of PES signal 300, i.e., the higher PES magnitudes, occurs at lower frequencies, e.g., at or below about 500 Hz, as shown at 306.

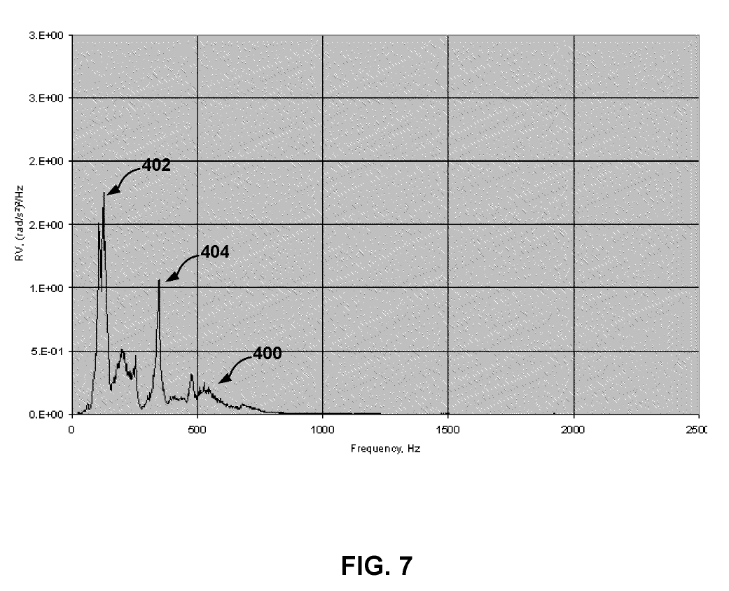

FIG. 7 depicts a graph illustrating rotational vibration data measured with accelerometers mounted external to data storage device 100, e.g., to top cover 104. The y-axis represents the magnitude of the rotational vibration in (rad/s²)²/Hz and the x-axis represents frequency in Hz. As seen in FIG. 7, the highest magnitudes of the rotational vibration measurement 400, indicated by 402 and 404, occur at lower frequencies, e.g., below about 500 Hz. The results shown in FIG. 7 correspond with the results shown in FIG. 6. That is, both graphs illustrate that frequencies below about 500 Hz should be investigated as a source of system resonance.

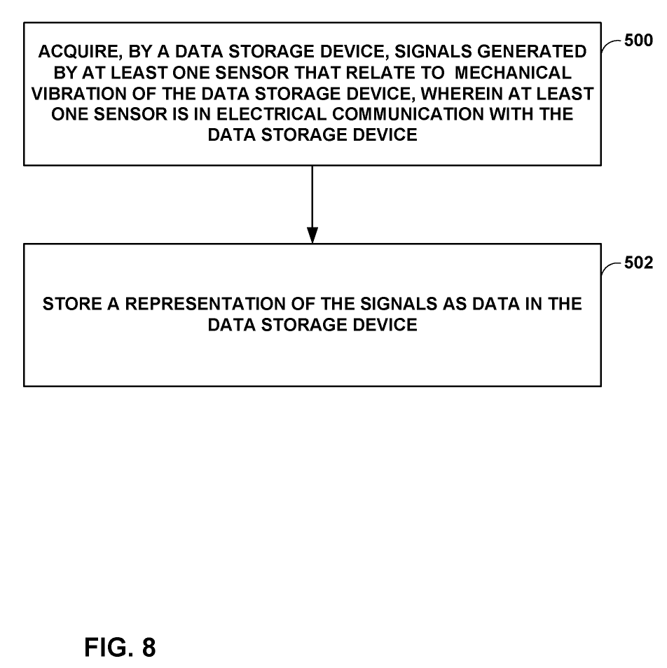

FIG. 8 is a flow chart illustrating an example method for using a data storage device as a data acquisition system for LV and RV, in addition to being a storage device. In the method illustrated in FIG. 8, data storage device 100, via processor 202 executing instructions, e.g., from first module 250, acquires signals generated by one or more sensors 210A and/or 210B in electrical communication with data storage device 100 that relate to a mechanical vibration of data storage device 100 (500). In one example, data storage device may begin acquiring signals in response to modification, e.g., by a customer, of a mode page setting by the changing a bit, for example. In another example, the data storage device may begin acquiring signals in response to receiving specific action code, e.g., an SCT command may be sent to a data storage device having an ATA interface using a specific action code. Sensors 210A and/or 210B may be, for example, linear vibration sensors, humidity sensors, temperature sensors, and accelerometers. Data storage device 100 may be, for example, a magnetic disc drive, an optical disc drive, a solid-state drive, or another storage device. In one example, two or more sensors may be necessary, wherein each of the two or more sensors is configured to detect rotational vibration in data storage device 100. Data storage device 100 then stores a representation of the signals as data in data storage device 100 (502). In some examples, the data comprises rotational vibration data.

In one example, processor 202 compares the data stored to a threshold value, e.g., an RV profile of data storage device 100, and provides a warning, e.g., a visual indication via LEDs 244, if the data exceeds the threshold value.

In some examples, if the data exceeds the threshold value, processor 202 may execute instructions, e.g., from second module 252, that store additional data, e.g., the frequency content, the LV and x-y coordinates from sensors 210A and/or 210B, the RV (after the RV has been calculated from the LV and x-y coordinates, or measured by RV sensors), and a time-stamp (day and time) indicating when the error condition occurred. Processor 202 may compare the additional data to at least one limit, e.g., an on-cylinder limit, and perform a transform, e.g., a fast Fourier transform, on the additional stored data to transform the data into a different domain, e.g., the frequency domain, and store the transformed data to data storage device 100. Processor 202 may compare the transformed data to a rotational vibration profile of the data storage, e.g., an RV profile required by the product specifications. If processor 202 determines that the transformed data is outside the profile, e.g., the energy or magnitude of the signal exceeds the product specification, then processor 202 may store an error code in the data storage device, servo data, UDS, or error logging data.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

The implementations described above and other implementations are within the scope of the following claims.

1. A method comprising:
acquiring, by a data storage device, signals generated by at least one sensor that relate to a mechanical vibration of the data storage device, wherein the at least one sensor is in electrical communication with the data storage device; and
storing a representation of the signals as data in the data storage device.

2. The method of claim 1, wherein the at least one sensor comprises two sensors, wherein each of the two sensors is configured to detect rotational vibration in the data storage device, and wherein the data comprises rotational vibration data.

3. The method of claim 2, further comprising:
comparing the data to a threshold value; and
providing a warning if the data exceeds the threshold value.

4. The method of claim 3, wherein providing a warning comprises providing a visual indication.

5. The method of claim 3, wherein if the data exceeds the threshold value, the method further comprises:
storing additional data in response to the data exceeding the threshold value;
comparing the additional data to at least one limit;
performing a transform on the additional data into a different domain;
storing the transformed data to the data storage device;
comparing the transformed data to a rotational vibration profile of the data storage device; and
if the transformed data is outside the profile, then storing an error code in the data storage device.

6. The method of claim 1, wherein the data storage device is selected from a group consisting of a magnetic disc drive, an optical disc drive, and a solid-state drive.

7. The method of claim 1, wherein the at least one sensor is selected from a group consisting of a linear vibration sensor, a humidity sensor, a temperature sensor, and an accelerometer.

8. The method of claim 1, wherein the acquisition of signals is invoked in response to modification of a mode page setting or in response to receiving specific action code.

9. A system comprising:
a data storage device; and
at least one sensor that generates signals related to a mechanical vibration of the data storage device, wherein the at least one sensor is in electrical communication with the data storage device, and wherein the data storage device acquires the signals and stores a representation of the signals in the data storage device.

10. The system of claim 9, wherein the at least one sensor comprises two sensors, wherein each of the two sensors is configured to detect rotational vibration in the data storage device, and wherein the data comprises rotational vibration data.

11. The system of claim 10, wherein the data storage device:
compares the data to a threshold value; and
provides a warning if the data exceeds the threshold value.

12. The system of claim 11, further comprising light-emitting diodes, wherein when the data storage device provides a warning, the data storage device provides a visual indication via the light-emitting diodes.

13. The system of claim 11, wherein if the data exceeds the threshold value, the data storage device:
stores additional data in response to the data exceeding the threshold value.
compares the additional data to at least one limit;
performs a transform on the additional stored data into a different domain;
stores the transformed data to the data storage device;
compares the transformed data to a rotational vibration profile of the data storage device; and
if the transformed data is outside the profile, then the data storage device stores an error code in the data storage device.

14. The system of claim 9, wherein the data storage device is selected from a group consisting of a magnetic disc drive, an optical disc drive, and a solid-state drive.

15. The system of claim 9, wherein the at least one sensor is selected from a group consisting of a linear vibration sensor, a humidity sensor, a temperature sensor, and an accelerometer.

16. The system of claim 9, wherein the acquisition of signals is invoked in response to modification of a mode page setting or in response to receiving specific action code.

17. A computer-readable medium comprising instructions that cause a processor in electrical communication with a data storage device to:
acquire signals generated by at least one sensor that relate to a mechanical vibration of the data storage device, wherein the at least one sensor is in electrical communication with the data storage device; and
store a representation of the signals as data in the data storage device.

18. The computer-readable medium of claim 17, wherein the at least one sensor comprises two sensors, wherein each of the two sensors is configured to detect rotational vibration in the data storage device, and wherein the data comprises rotational vibration data.

19. The computer-readable medium of claim 18, further comprising instructions that cause a processor in electrical communication with a data storage device to:
compare the data to a threshold value; and
provide a warning if the data exceeds the threshold value.

20. The computer-readable medium of claim 19, wherein the instruction that causes the processor to provide a warning comprises instructions that cause the process to provide a visual indication.

21. The computer-readable medium of claim 19, wherein if the data exceeds the threshold value, the computer-readable medium further comprises instructions that cause the processor to:
store additional data in response to the data exceeding the threshold value.
compare the additional data to at least one limit;
perform a transform on the additional stored data into a different domain;
store the transformed data to the data storage device;
compare the transformed data to a rotational vibration profile of the data storage device; and
if the transformed data is outside the profile, then store an error code in the data storage device.

22. The computer-readable medium of claim 17, wherein the data storage device is selected from a group consisting of a magnetic disc drive, an optical disc drive, and a solid-state drive.

23. The computer-readable medium of claim 17, wherein the at least one sensor is selected from the group consisting of a linear vibration sensor, a humidity sensor, a temperature sensor, and an accelerometer.

24. The computer-readable medium of claim 17, wherein the instructions that cause the processor to acquire signals generated by at least one sensor are executed in response to modification of a mode page setting.

25. A system comprising:
a data storage device;
at least one sensor that generates signals related to a mechanical vibration of the data storage device, wherein the at least one sensor is in electrical communication with the data storage device, and wherein the data storage device acquires the signals and stores a representation of the signals in the data storage device; and
a cabinet configured to support the data storage device and one or more other data storage devices.
